(19) United States
(12) Patent Application Publication
(10) Pub. No.: US 2018/0331710 A1
(43) Pub. Date: Nov. 15, 2018

(54) Radio modulation technique using DMPSK for immproved BER

(71) Applicants: John Lovberg, San Diego, CA (US); Vladimir Kolinko, San Diego, CA (US); Richard Chedester, Whately, MA (US)

(72) Inventors: John Lovberg, San Diego, CA (US); Vladimir Kolinko, San Diego, CA (US); Richard Chedester, Whately, MA (US)

(21) Appl. No.: 15/998,058

(22) Filed: Jun. 20, 2018

Related U.S. Application Data
(63) Continuation of application No. 14/998,988, filed on Mar. 14, 2016, now abandoned.
(60) Provisional application No. 62/604,014, filed on Jun. 20, 2017.

(51) Int. Cl. H04B 1/40; H04L 27/20; H04W 72/04; H04L 27/233

(52) U.S. Cl. CPC H04B 1/40; H04L 27/2039; H04L 27/2332; H04W 72/0453

(57) ABSTRACT

A millimeter wave radio link in which the transceivers have most of its components fabricated on a single chip or chipset of a small number of semiconductor chips. The chip or chipsets when mass produced is expected to make the price of millimeter wave radios comparable to many of the lower-priced microwave radios available today from low-cost foreign suppliers. Preferred embodiments of the present invention operate in the range of about 3.5 Gbps to more than 10 Gbps. The transceivers of a preferred embodiment are designed to receive binary input data at an input data rate in 10.3125 Gbps and to transmit at a transmit data rate in of 10.3125 Gbps utilizing encoded three-bit data symbols on a millimeter carrier wave at E-Band frequencies. Preferred embodiments include an averaging technique that greatly improves bit error rates. A constellation averaging technique is utilized to improve bit error rates.

### CROSS REFERENCE TO RELATED APPLICATIONS

This application claims the benefit of Provisional Application Ser. No. 62/604,014, filed Jun. 20, 2117. The application is a continuation in part of U.S. patent application Ser. No. 14/998,988 filed Mar. 14, 2016 which was a continuation in part of Ser. No. 12/930,947 filed Jan. 20, 2011 (now U.S. Pat. No. 9,300,508) which was a CIP of and Ser. No. 12/928,017 filed Nov. 30, 2010 (now U.S. Pat. No. 9,008,212) which was a CIP of Ser. No. 12/228,114 filed Aug. 7, 2008 (now U.S. Pat. No. 8,098,764), all of which are incorporated herein by reference.

### FIELD OF THE INVENTION

The present invention relates radio systems and methods of radio communication and in particular to methods for coding and decoding radios utilizing phase shift keying.

### BACKGROUND OF THE INVENTION

### Last Mile and Middle Mile Communication Services

The United States and many other countries are crisscrossed by many thousands of miles of fiber optic communications links providing almost unlimited communication between major population centers. Telephone companies provide communications services to nearly all of the homes and offices in the United States and many other countries, but existing telephone services in many areas provide only low speed (i.e. low data rate) connections. Communication companies are rapidly improving these last mile services with cable and fiber optic connections, but installation of cable and fiber optic systems is expensive, and a large number of people are still without access to high speed communication services. Microwave radios have been used for many years for last mile and middle mile communication services, but bandwidths for these systems are typically limited such that data rates available are typically much less than 1 Gbps. Communication companies are beginning to utilize millimeter wave radios to provide these services but the data rates of most of these radios, although much greater than the microwave systems, are currently limited to about 1 Gbps. Many cellular systems are becoming overloaded due to the increased bandwidth required by the iPhones and similar “smart” phone and other consumer products and existing backhaul facilities are fast becoming inadequate.

### High Data Rate Protocols

A popular communication protocol which is being increasingly utilized to meet this demand for increased bandwidth is the Internet Protocol (IP) 10 Gigabit Ethernet Standard at 10 gigabits per second, with a small amount of overhead for ensuring carrier modulation (bit toggling) at some minimum speed. Hereinafter “10 GbE” shall refer to features this 10 Gibabit Ethernet Standard. There are, however, many current wired and fiber communications standards that use transceivers for serial transfer of binary data at speeds in excess of 4 Gigabits per second. Some of these include: SONET OC-96 (4.976 Gbps); 4×Gig-E (5.00 Gbps); 5×Gig-E (6.25 Gbps); OBSAI RP3-01 (6.144 Gbps); 6×Gig-E (7.50 Gbps); Fibre Channel 8GFC (8.5 Gbps); SONET OC-192 (9.952 Gbps) and Fibre Channel 10GFC Serial (10.52 Gbps).

### Semiconductor Technology

Recent advances in semiconductor technology have enabled the fabrication of increasingly complex mixed-signal (analog/digital) circuitry on a single integrated circuit chip or a chipset containing a minimal number of chips. A chip refers to a group of integrated circuits on a single substrate and a chipset refers to a set of chips that are designed to work together. Chipsets are usually marketed as a single product. Such circuitry has included analog microwave and millimeter-wave front-end amplifiers, filters, oscillators, and mixer/down-converters, as well as intermediate-frequency electronics, phase-lock loops, power control and back-end analog baseband circuitry, along with digital modulators and de-modulators, clock recovery circuits, forward error correction and other digital data management functions. Mixed-signal integrated chip solutions for wireless communications have universally evolved from RF frequencies below 1 GHz (e.g. 900 MHz handsets for wireless telephone in the home) to low microwave frequencies (analog/digital cell phone technology with carrier frequencies up to 2 GHz), to high microwave and low millimeter-wave frequencies (6 to 38 GHz) for wireless point-to-point broadband communications. Most recently, radio receivers and transmitters have been demonstrated using single-chip circuits at frequencies in the license-free band spanning 57 to 64 GHz. These circuits have been based on techniques that have been successfully applied to lower frequency radios. Fui example, these prior art radio-on-a-chip designs have featured heterodyne and super-heterodyne circuits with relatively narrow (<1 GHz) baseband frequency channels for modulation and demodulation, because the symbol rate was constrained far below 1 billion symbols per second by the channel bandwidth available for microwave radios.

### Silicon CMOS Technology

Recent advances in semiconductor lithography processes have enabled smaller gate features (<30 nm) in silicon. At these feature sizes, silicon complementary metal-oxide-semiconductor (referred to as “Si CMOS”) technology is capable of reaching cutoff frequencies well in excess of 100 GHz for the first time. While SiGe offers advantages in amplifier noise figure and output power, Si CMOS technology is unparalleled for low cost, and offers the ability to combine high frequency analog front end and conventional digital processing electronics (FPGAs, ADCs, DACs, and DSPs) on a single mixed-signal chip or small set of such chips.

### Quadrature Amplitude Modulation

Two key conditions dictated early microwave radio designs for fixed point-to-point communications: 1) very limited available bandwidth in which to transmit as much data as possible, and 2) minimal dynamic range variation associated with rain fade and other weather or atmospheric variations. The first of these conditions dictated the adoption of very high-order modulation techniques such as quadrature amplitude modulation (QAM). For example, 64-QAM, 128-QAM, or 256-QAM systems are in use for microwave links in which several (such as 6 to 8) digital bits can be sent simultaneously using a single pseudo-digital symbol, thereby increasing spectral throughput (bits per second per Hertz), but using such modulation schemes, a penalty of 17 to 22 dB in transmitter power is incurred relative to single-bit symbol modulation (on-off keying or binary phase shift keying) to maintain a manageable bit error rate. The second key condition driving earlier designs, the comparatively lower atmospheric attenuation and weather fade characteristic of lower frequencies, made such modulation efficiency trades desirable for microwave radios, by requiring little additional link margin to cope with high humidity and heavy rainfall. These QAM techniques work well on microwave systems, but have not been successfully applied to millimeter wave communication systems designed for longer propagation paths (e.g. exceeding two kilometers).

### Phase Shift Keying

Phase-shift keying (PSK) is a digital modulation scheme that conveys data by changing (modulating) the phase of a reference signal (the carrier wave). The modulation occurs by varying the relative amplitudes of sine and cosine inputs at a precise time. It is widely used for wireless communication.

Any digital modulation scheme uses a finite number of distinct signals or symbols to represent digital data. PSK uses a finite number of phases, each phase assigned a unique pattern of binary digits. Usually, each phase encodes an equal number of bits. Each pattern of bits forms the symbol that is represented by the particular phase. The demodulator is designed specifically for the symbol-set used by the modulator; it determines the phase of the received signal and maps it back to the symbol it represents, thus recovering the original data. This requires the receiver to be able to compare the phase of the received signal to a reference signal. Systems which require the receiver to have knowledge of the phase of the transmitter is referred to herein as ordinary phase shift keying (PSK). Alternatively, instead of operating with respect to a constant reference phase, the receiver can utilize changes in phase to modulate and demodulate the transmitted signal. In this case changes in phase of a single broadcast waveform are considered the significant items. In this system, the demodulator determines the changes in the phase of the received signal rather than the phase (relative to a reference wave) itself. Since this scheme depends on the difference between successive phases, it is termed differential phase-shift keying (DPSK). DPSK can be significantly simpler to implement than ordinary phase shift keying (typically referred to simply as PSK), since there is no need for the demodulator to have a copy of the reference signal to determine the exact phase of the received signal. It is a non-coherent scheme. As a result, it may produce more erroneous demodulations than ordinary PSK.

A convenient method to represent PSK schemes is on a constellation diagram. This shows the points in the complex plane where, in this context, the real and imaginary axes are termed the in-phase and quadrature axes respectively due to their 90° separation. Such a representation on perpendicular axes lends itself to straightforward implementation. The amplitude of each point along the in-phase axis may be used to modulate a cosine wave and the amplitude along the quadrature axis may be used to modulate a sine wave.

In PSK, the constellation points chosen are usually positioned with uniform angular spacing around a circle. This gives maximum phase-separation between adjacent points and thus the best immunity to corruption. They are positioned on a circle so that they can all be transmitted with the same energy. In this way, the moduli of the complex numbers they represent will be the same and thus so will the sum squared—amplitudes needed for the cosine and sine waves. Two common examples are “binary phase-shift keying” (BPSK or 2PSK) which uses two phases and “quadrature phase-shift keying” (QPSK or 4PSK) which uses four phases, although any number of phases may be used. Since the data to be conveyed are usually binary, the PSK scheme is usually designed with the number of constellation points being a power of 2 (such as 4, 8, 16, 32 or 64) with the number chosen sometimes referred to as “phase state” or the “m-state” or MPSK where m or M is the specific power-of-2 number being utilized.

### Specific PSK Techniques

Radio noise performance (for example, bit-error rate or BER) is dependent on the fidelity of the decoding scheme. Common decoding schemes normally require precise recovery of the carrier and clock signals from a remote transmitter/encoder to accurately reproduce the transmitted data stream without error. Carrier recovery techniques for m-state phase shift keying (MPSK), such as Costas loops, are inherently expensive, complex and difficult to calibrate. Such carrier recovery techniques cannot reproduce the absolute phase state of a transmitted signal, but instead require transmission from the transmitter of periodic, recognizable “training sequences” to orient the symbol constellation at the receiver. Phase noise on the transmitted carrier must be minimized between training intervals to keep error in measurements of absolute phase to a minimum.

### Differential MPSK

The use of differential MPSK, for which the phase shift between symbols is used to encode and decode the data stream, eliminates the need for determining absolute phase of the transmitted signal. In addition, since the phase shift at a symbol transition is only a weak function of carrier frequency, the need for precise replication of the remote transmitter's carrier frequency is eliminated. Differential MPSK, (or DMPSK) decoding may be accomplished by quadrature mixing of the received signal by a replica of the same signal delayed by one symbol period; the in-phase (I) and quadrature-phase (Q) components of this mixing then directly determine the inter-symbol phase shift. While simple and cost-effective, this technique increases the receiver's noise threshold by 6 dB relative to ideal coherent decoding where the phase of the transmitted signal is known by the receiver transmitted to the receiver, because noise on the carrier contributes to the measured phase change.

### Coherent Differential MPSK

Coherent differential modulation is demodulation using a clean coherent frequency reference which is generated locally in the receiver, and which need only be an approximate replica of the received signal carrier. A difference in frequency between the remote carrier and the local carrier reference causes a rotation of the vector symbol constellation in the phase plane. For a frequency change which is small relative to the symbol rate of the modulator (e.g. 100 kHz frequency offset for a 3.6 Gsps modulation rate), the additional inter-symbol phase shift due to rotation is negligible (0.01 degree of phase in this example). This approach eliminates the expense of a precise carrier recovery circuit altogether, as well as the need for absolute symbol phase determination, and also eliminates the threshold noise contribution from the remote carrier. Unfortunately, since differential modulation/demodulation techniques require the comparison of two sequential phase states to determine inter-symbol phase shift, the RMS phase error is higher than that of either of the individual phase measurements, by a factor of the square-root of two. This degrades the BER performance of the radio relative to that of the ideal direct-modulated radio.

### E-Band Radios

Telecommunications providers and others have attempted in the past to utilize the various wireless technologies for the delivery of last-mile communications services to businesses as an alternative to the installation of fiber. A viable wireless alternative to fiber needs to provide high-speed transmission rates, the ability to establish links between distances that are meaningful within a metropolitan area and the ability to power through rain and other weather conditions. In addition, a wireless alternative to fiber needs to be quickly deployable and materially more cost-efficient than fiber. A result of the physical characteristics of the portions of the spectrum in which current wireless technologies operate, and the performance limitations of the products based on these technologies, they fail to meet the criteria necessary to prove them viable alternatives to fiber.

In January of 2003, the United States Federal Communications Commission (with encouragement from Applicants' employer, Trex Enterprises Corporation, its subsidiary Loea Corporation and others) put forth a new rulemaking in which 10 GHz of bandwidth, comprising (E-Band) frequency channels, were opened for short range, high bandwidth, point-to-point radio communications without restrictions on modulation efficiency. The unique characteristic of this rulemaking was that for the first time a large section of bandwidth would be shared based on locational constraints rather than spectral (channelizing) constraints. Each user of the new frequency bands was free to use the entire available bandwidth (e.g. 5 GHz in each of the 71-76 GHz and 81-86 GHz bands) as long as the transmit/receive path was confined within a single very narrow channel (“pencil beam” less than 1.2 degrees wide) in 3-dimensional space. However, rain fade at E Band can reach up to 35 dB/km, versus 1 dB/km at 6 GHz, so much larger link margins must be maintained at E Band, relative to lower frequency microwave bands, to accommodate severe weather events. On the other hand, the 5 GHz channel bandwidths available at E-Band are more than twenty times as wide as the widest channels available at microwave frequencies, so data rates in the range of 1 Gbps (unheard of for microwave radios) are made possible using simple on-off keying or binary phase-shift keying.

Applicants' employer led the way in the development of the early millimeter wave radios. Several patents describing these early radios have been awarded to Applicants and their fellow workers and assigned to Applicants' employer. These patents include the following patents:

| PAT. | | |
|---|---|---|
| NO. | ISSUED | TITLE |
| U.S. Pat. No. 6,556,836 | Apr. 29, 2003 | Point to Point Millimeter Wave Dual Band Free Space Gigabit per |
| | | Second Communication Link |
| U.S. Pat. No. 6,665,546 | Dec. 16, 2003 | High Speed Point-to-Point Millimeter Wave Data Communication |
| | | System |
| U.S. Pat. No. 6,714,800 | Mar. 30, 2004 | Cellular Telephone System with Free Space Millimeter Wave |
| | | Trunk Line |
| U.S. Pat. No. 7,062,283 | Jun. 13, 2006 | Cellular Telephone System with Free Space Millimeter Wave |
| | | Trunk Line |
| U.S. Pat. No. 7,065,326 | Jun. 20, 2006 | Millimeter Wave Communication System with a High |
| | | Performance Modular Circuit |
| U.S. Pat. No. 7,680,516 | Mar. 16, 2010 | Mobile Millimeter Wave Communication Link |
| U.S. Pat. No. 7,769,347 | Aug. 3, 2010 | Wireless Communication System |
| U.S. Pat. No. 8,098,764 | Jan. 17, 2012 | Millimeter Radio with Phase Modulation |
| U.S. Pat. No. 8,385,977 | Feb. 26, 2013 | Cellular Communication System with High Content Distribution |
| U.S. Pat. No. 9,008,212 | Apr. 14, 2015 | High Data Rate Millimeter Radio |
| U.S. Pat. No. 9,300,508 | Mar. 29, 2016 | High Data Rate Millimeter Wave Radio on a Chip |

### The Need

What is needed is a millimeter wave radio on a chip or chipset designed appropriately to deal with the added complexities associated with these higher frequencies, and at the same time configured to take advantage of the much higher bandwidth available in the frequency ranges above 70 GHz, to obtain data rate capacities in excess of 4 Gbps, all with minimum BERs.

### SUMMARY OF THE INVENTION

The present invention provides a high data rate millimeter wave radio system and method utilizing differential quadrature modulation and phase shift keying and special coding including a constellation averaging technique providing a several orders of magnitude reduction in bit error rates.

A first embodiment is a 10 GbE Ethernet radio transceiver designed to operate in the licensed range from 71-76 GHz and 81-86 GHz having all or substantially all of its components fabricated on a single chip or a chipset of a small number of semiconductor chips. The chips or chipsets when mass produced are expected to make the price of millimeter wave radios comparable to many of the lower-priced microwave radios available today from low-cost foreign suppliers. Other preferred embodiment may operate in other frequency ranges where bandwidths greater than 1 GHz are available, such as the license free range from 57-64 GHz. Some embodiments of the present invention are designed to utilize the entire available bandwidth, greater than 1 GHz, for modulation and demodulation. Transceivers of the present invention operate at data rates in the range of about 1 Gbps to more than 10 Gbps. The transceiver of the first preferred embodiment is designed to receive binary input data at an input data rate in 10.3125 Gbps and to transmit at a transmit data rate in of 10.3125 Gbps utilizing encoded three-bit data symbols on a millimeter carrier wave at a millimeter wave nominal carrier frequency in excess of 50 GHz. The radio uses differential phase-shift keying utilizing eight separate phase shifts. Embodiments of the invention can be used to support many of the high data rate standards including the following group of protocols or standards: SONET OC-96 (4.976 Gbps); 4×Gig-E (5.00 Gbps); 5×Gig-E (6.25 Gbps); OBSAI RP3-01 (6.144 Gbps); 6×Gig-E (7.50 Gbps); Fibre Channel 8GFC (8.5 Gbps); SONET OC-192 (9.952 Gbps); 10 GbE (10.3125 Gbps) and Fibre Channel 10GFC Serial (10.52 Gbps).

For highest frequency stability and lowest phase noise, an external oscillator phase-locked to a temperature-controlled crystal is used as the frequency reference for a Si-CMOS-chip-based 10 Gbb radio, but all other radio circuit components, including the frequency multiplier chain, up-conversion and down-conversion mixers and millimeter-wave, microwave and baseband amplifiers, data encoder, digital-to-analog converter, vector modulator and demodulator mixers, analog-to-digital convertor, inter-symbol interference filter and all other baseband and digital data and control electronics are implemented using standard CMOS processes on the same silicon substrate or a small number of such substrates. Preferably, peripheral radio components such as fiber-optic transceivers, frequency generators, filters, power supplies and regulators, high-power amplifiers, diplexers and antenna systems are external to the radio chip. A Si CMOS foundry with a 0.028-micron (or smaller) lithography process, such as the TSMC foundry located in Hsinchu, Taiwan, can produce Si CMOS chips of the preferred design for 10 GbE-Band radio transceivers

### Preferred Embodiment

### A 10 Gigabit Per Second Millimeter Wave Radio

This first preferred embodiment of the present invention is a 10-gigabits-per-second radio transceiver operating with carrier signals in the frequency ranges of 71-76 GHz and 81-86 GHz. This transceiver includes a transmitter transmitting in the 71-76 GHz band and a receiver receiving in the 81-86 GHz band, or a transmitter transmitting in the 81-86 GHz band and a receiver receiving in the 71-76 GHz band. Two of these transceivers constitute a millimeter-wave radio link designed to operate in accordance with the 10 Gigabit Ethernet Standard (which is sometime referred to as 10 GE, 10 GbE and 10 GigE). In preferred embodiments all of the components of the transceiver are fabricated on a single chip or chipset except the antenna systems, optical fiber input/output transceivers, diplexers, delay lines, frequency generators, power amplifiers and voltage regulators.

In this embodiment the transmitter for each transceiver supports a digital data rate of 10.3125 Gbps (10 Gigabits raw data per second plus IEEE 802.3 Clause 49 64b/66b encoding which accounts for the 0.3125 Gbps excess), using 3-bit symbol encoding (e.g. 8PSK). The carrier phase is modulated at a symbol rate of 3.4375 billion-symbols-per-second, so as to fit easily into the 5 GHz channel modulation bandwidth allowed by the prevailing FCC band plan for E-Band communication. During each (approximately 291 picoseconds) symbol period, 3 bits of data are clocked into a temporary data buffer and then compared to the previous 3 bits using a look-up table (LUT) to establish the appropriate digital command words for driving the phase modulator. Two such 12-bit command words are directed to separate digital-to-analog converters (DACs) to create the drive voltages for the phase modulator's in-plane (I) and quadrature (Q) vector components. A nearly-instantaneous phase shift is then imposed onto the transmitted carrier signal, each shift representing a specific digital symbol. This phase shift comprises one of eight standard phase shifts, with the degree of shift depending on the three-bit pattern of the new symbol. In a preferred embodiment the phase shift is either 0°, 45°, 90°, 135°, 180°, 225°, 270° or 315°. In one possible embodiment each of these phase shifts respectively represent a symbol consisting of a combination of binary bits, each combination being one of 000 to 111, as shown in the following table:

| | |
|---|---|
| 0° | 000 |
| 45° | 001 |
| 90° | 010 |
| 135° | 011 |
| 180° | 100 |
| 225° | 101 |
| 270° | 110 |
| 315° | 111 |

In all preferred embodiments the receiver in each transceiver includes a demodulator with a sequential state phase comparator that detects and evaluates the received signal to reconstruct the three data bits from each symbol.

The transmitter in this embodiment, designed to operate at 71-76 GHz or 81-86 GHz, includes a frequency stabilized millimeter wave source operating at the millimeter wave carrier frequency (preferably centered at 73.5 GHz or 83.5 GHz; an encoder having an output clocked at the on-off keyed input data rate divided by three; a digital LUT combining three new bits with three previous bits to form an input, with an output of two digital control words; a pair of ADC's converting control words to vector I and Q phase modulator control voltages; and a modulator adapted to use the generated I and Q control voltages to apply a modulation to the millimeter carrier wave in the form of a single phase shift for each three-bit symbol, each phase shift being one of eight standard, recognizably distinct phase shifts. The receiver is adapted to receive an incoming millimeter wave signal transmitted from a remote millimeter wave transmitter transmitting at frequencies in excess of 70 GHz and to reconstruct communications data sent from the remote transmitter. The receiver of this preferred embodiment includes a millimeter wave amplifier adapted to amplify the incoming millimeter wave signal and a demodulator adapted to decode the incoming millimeter wave signal to produce a binary output data stream at an output data rate of 10.3125 Gbps.

### Preferred Embodiment

### Coding

The general radio modulator as described above does not use Gray encoding of the data signal, but uses a standard binary progression of three-bit words as the 8PSK constellation is traced counter-clockwise around the complex (I/Q) plane. When data belonging to a given symbol state (constellation point) is erroneously interpreted as belonging to an adjacent state, any number of bit errors can result; for instance a 135° phase jump, which might be encoded as a ‘011’, could be mistaken for a 180° phase jump, which could be encoded as a ‘100’. In this case all three bits in the word would be in error. However, a preferred embodiment of this invention does use Gray coding, which forces data words corresponding to adjacent points on the constellation to differ by only a single bit value. For this version, the 135° phase jump might represent the three bits ‘010’, while the 180° phase jump could represent ‘110’. An error in interpretation between these two states thus results in only a single bit error, delivering a three-fold improvement in bit-error performance relative to the no-encoding example in the previous embodiment.

This embodiment uses a digital signal modulator driver comprised of a fast Field-Programmable Gate Array (FPGA) with an algorithm that compares the last six bits (i.e., two symbols) of the data stream to a Gray-encoded differential phase look-up-table (LUT) to deliver digital control values to the fast DACs driving the vector signal modulator.

This embodiment also uses a frequency generation scheme whereby the transmitted carrier frequency is derived from the same frequency reference as the transmitted data clock. The data clock can be recovered accurately with an edge detector in the receiver, and using the same known frequency multiply and divide ratios as those utilized in the remote transmitter, the transmitter carrier can be reconstructed from the data clock (to within a constant offset phase, which is rendered irrelevant by differential 8PSK [D8PSK] modulation). This eliminates the need for expensive carrier recovery electronics (such as a Costas loop) altogether and provides improved stability.

This embodiment uses a digital signal demodulator, comprised of a pair of fast digitizers and an I/Q mixer, to determine the vector amplitudes of the transmitted in-phase and quadrature signals. The phase change between symbols is inferred (in the FPGA) from changes in the calculated I- to Q-channel amplitude ratio, and a look-up table on the FPGA is used to Gray-decode and convert the inferred phase change to a three-bit data stream.

### Inter-Symbol Interference Equalization

This embodiment of the radio incorporates a Finite-Impulse-Response (FIR) filter pre-programmed into the FPGA to compensate the received signal for any distortion caused by the band limiting of the transmitted signal. This filter convolves a FIR transfer function, developed through prior training of the receiver against known transmission patterns, across the digitized signal waveform to clean up distortion prior to data decoding in the FPGA. This improves radio bit-error performance relative to the radio without inter-symbol interference equalization, and relaxes the requirements for extremely flat amplifier gain and constant filter group delay across the modulated signal bandwidth.

### Other Preferred Embodiments

Preferred embodiments include two-transceiver E-Band radio links, with D8PSK modulation and demodulation, capable of 10.3125 Gbps operation. These embodiments preferably include a first transceiver designed to transmit at a first E-Band frequency band and to receive at a second E-Band, each of the two bandwidths, defining a first and second E-Band bandwidth, being at least as wide as 3.5 GHz. The second transceiver preferably transmits at the second E-Band and receives at the first E-band. Preferably the bandwidths are the full 5 GHz as allowed for E-Band radios at 71-76 GHz ant 81-86 GHz in the United States.

### The First Transceiver

### Front End Circuitry

The first transceiver includes front-end circuitry, all of which or mostly all of which is fabricated on a single chip or chipset. The front end circuitry receives a binary input data stream and is designed with a capability of producing output signals at data rates at least as fast as 10.3125 Gbps utilizing D8PSK modulation of an E-Band carrier signal with the transmitter front-end circuitry comprising: encoding circuitry adapted to encode input binary signals to produce encoded signals, with each encoded signal comprising three bits; and D8PSK modulation circuitry adapted to phase shift the millimeter wave carrier signal based on the encoded signals to produce a phase-shifted carrier signal at the first E-Band frequency band with each phase of the signal defining one of eight phases, having spacing between the phases of about 45 degrees or a multiple of about 45 degrees.

### Receiver Circuitry

The first transceiver includes receiver circuitry, all of which or mostly all of which are fabricated on a single chip or chipset, adapted to receive incoming E-Band signals transmitted from the second transceiver at the second E-Band frequency millimeter wave transmitter. This receiver circuitry will preferably include: millimeter wave amplifier circuitry adapted to amplify incoming E-Band signals and demodulation circuitry adapted to demodulate the amplified incoming millimeter wave signals to produce a binary output data stream.

### Radio Transmit and Receive Components

The first transceiver also includes radio transmit and receive components for transmitting and receiving phase-shifted E-band radio signals to and from the second transceiver. These radio components comprise: millimeter wave amplifier circuitry for amplifying the phase shifted carrier signal to produce an amplified phase shifted transmit E-Band radio beam and millimeter wave amplifier circuitry adapted to amplify phase-shifted carrier signals received from the second transceiver.

### Antenna System

The first transceiver will need an antenna system adapted to convert the phase shifted E-band radio transmit beams to produce a narrow band E-Band “pencil beam” confined within a single narrow channel less than 1.2 degrees wide and to collect phase shifted E-band radio beams transmitted from the second transceiver.

### The Second Transceiver

Millimeter wave radio links of the present invention includes a second transceiver substantially similar to the first transceiver to communicate with the first transceiver except the second transceiver has components designed to transmit at the receive frequency band of the first transceiver and to receive at the transmit frequency band of the first transceiver.

In preferred embodiments the transmitter front-end circuitry of both transceivers are adapted to derive their internal clock references directly from 10 GbE fiber or coaxial cable data input, and to generate symbol clock, intermediate frequencies and transmit frequencies from their internal clock references. In these preferred embodiments both transceivers derive their receiver symbol clock from their 10 GbE antenna data input, with the result that the receiver internal symbol clock of each of the transceivers is slaved to the transmitter clock of the other transceiver and is fully independent of internal transmit clock of the transceiver. Also, the receiver circuitry of each of the two transceivers utilizes an edge detector comprised of a delay and sum interference circuit, using a half wave delay of the intermediate frequency receive signal to detect and synchronize to phase jumps and to generate its demodulator symbol clock, receiver intermediate frequencies and local oscillator frequencies from this derived internal receive clock, thus eliminating the need for a Costas loop or other carrier recovery circuit. In addition, receiver circuitry of each of the two transceivers is adapted to decode data based on differential phase between successive symbols, eliminating a need for a common phase reference with the transmitter of the other transceiver.

In some embodiment the chips or chipsets are comprised of silicon germanium, but a preferred embodiment may utilize silicon complementary metal-oxide semiconductor (Si CMOS) technology for greatly reducing the cost of the radio links. In most embodiments peripheral radio components are needed external to the chips or chipsets. These include some or all of the following components: fiber-optic transceivers, frequency generators, filters, power supplies and regulators, high-power amplifiers, diplexers and antenna systems. Amplifier, clock recovery, mixers, frequency multiplies and dividers, edge detectors, and phase comparators, and digital processing electronics, including digitizers, FPGA's, digital to analog converters, are preferably fabricated on a single all-silicon CMOS semiconductor chips or chipsets. 17. Transmitters and the receivers may transmit and receive through separate antennas or through common antennas. Transmitters may be adapted to provide a dynamic range in power output exceeding 15 dB. The transmitter and the receiver portions of the transceivers may be contained in a single enclosure or separate enclosures.

### Other Embodiments

Other embodiments of the present invention include millimeter wave radios operating at data rates lower than about 10 Gbps. For radios operating at data rates much lower than about 10 Gbps, other modulation schemes may be preferred. For example, for data rates between about 1.25 Gbps to about 3.5 Gbps a Differential Binary Phase Shift Keying (DBPSK) modulation scheme is preferred. For data rates between about 3.5 GBPS to about 7 Gbps a Differential Quadrature Phase Shift Keying (DQPSK) modulation scheme is preferred.

In preferred embodiments operating at data rates in the range of about 3.5 Gbps the occupied transmit bandwidth is preferably between 1.0 GHz and 5 GHz. For data rates of the 10 GigE transceiver the occupied transmit bandwidth is preferably between 3.5 GHz and 5 GHz. Preferably the power spectrum density within more than 70 percent of the output power of the transmitter is constant to within +/−1.5 dB and the transceiver provides provide a dynamic range in power output exceeding 15 dB.

### BRIEF DESCRIPTION OF THE DRAWINGS

FIG. 1 describes the transmitter of a preferred embodiment.

FIG. 2 shows how data is handled by a fast FPGA and clocked into an array processor at a slower rate.

FIG. 3 shows a symbol “constellation” of the preferred embodiment.

FIG. 4 demonstrates the use of a high quality temperature controlled crystal oscillator (TCXO) to suppress phase noise.

FIG. 5 shows the use of digital to analog device to drive X and Y magnitudes for the symbol constellation.

FIG. 6 shows a clock and data recovery circuit.

FIG. 7 shows features of a receiver for detecting and demodulating the transmit signal.

FIG. 8 shows how the transmitter provides the clock for both the transmitter and the receiver.

FIG. 9 shows how the clock signal is used to control the ultra-stable TCXO.

FIG. 10 shows how the signal from the transmitter is filtered and how phase is compared to the previous phase to determine the size of the phase jump.

FIG. 11 is a symbol constellation of a radio using 8PSK modulation

FIG. 12 shows constellation for an 8PSK radio with an imperfect carrier in the receiver.

FIG. 13 demonstrates a phase change (including noise) from one symbol to the next.

FIG. 14 is a plot of complementary error function.

FIG. 15 demonstrates error reduction with averaging.

FIG. 16 demonstrates effects of averaging on angular blurring.

FIG. 17 demoushates a truncation of a binary representation.

FIG. 18 shows a 16 QAM constellation.

FIG. 19 shows a 64 QAM constellation.

FIG. 20 shows a 32-APSK constellation.

### DETAILED DESCRIPTION OF PREFERRED EMBODIMENTS

### Circuit Methodologies

As radio technology has evolved from low frequencies to higher and higher frequencies, the circuit methodologies optimized for the physical and practical constraints of lower-frequency communications were continually applied to higher frequency applications. This was done without consideration for differences in the physical and practical constraints characteristic of high frequency communications. As a result, previous attempts at delivering single-chip and minimal chipset solutions for frequencies above 64 GHz have not been successful at producing commercially viable radios at data rates exceeding 4 Gbps.

Two key conditions dictated early (lower frequency) chip designs for fixed point-to-point communications: 1) very limited available bandwidth in which to transmit as much data as possible, and 2) minimal dynamic range variation associated with rain fade and other weather or atmospheric variations. The first of these conditions dictated the adoption of very high-order modulation techniques such as 64-QAM, 128-QAM, or 256-QAM, in which several (6 to 8) digital bits could be sent simultaneously using a single pseudo-digital symbol, thereby increasing spectral throughput (bits per second per Hertz). The high-order modulation results in a penalty of 17 to 22 dB in transmitter power relative to single-bit symbol modulation (on-off keying or binary phase shift keying) to maintain a manageable bit error rate. The second key condition, the comparativcly lower atmospheric attenuation and weather fade characteristic of lower frequencies, made such modulation efficiency trades desirable for microwave radios, by requiring little additional signal to noise link margin to cope with high humidity and heavy rainfall.

### Silicon-Germanium Semiconductors

Silicon-germanium bipolar transistors on complementary metal-oxide-semiconductor (referred to as “SiGe BiCMOS”) technology, which marries the superior low-noise and high-speed properties of the SiGe heterojunction bipolar transistors with the low cost and manufacturability advantages of conventional CMOS technology, represent an ideal solution for mixed-signal applications such as millimeter-wave wireless communications systems, in which frequency sources and multipliers, mixers and low-noise amplifiers are used alongside digital modulator control and processing circuitry. Amplifiers using SiGe bipolar transistors are more efficient and achieve lower noise figures than comparable conventional CMOS amplifiers, and the higher breakdown voltage of SiGe allows for higher device output power as well.

### High Frequency Radio Components on Si and SiGe

Gallium Arsenide (GaAs) is superior to SiGe semiconductors for ultra-low phase noise high-frequency oscillators (so an external microwave phase-locked voltage-controlled oscillator (PLVCO) is a preferred frequency source), but the frequency multiplier chain, up-conversion and down-conversion mixers and millimeter-wave, microwave and baseband amplifiers can all be implemented satisfactorily using conventional microstrip circuitry on Si and SiGe semiconductor substrates. For lowest cost, a silicon wafer can be used as a substrate, with germanium placed locally on the chip at the locations of the millimeter-wave transistors and diodes, so that the SiGe material is localized only in the regions of the high-frequency MMW and microwave semiconductor junctions. Lower frequency circuitry, including the data encoder, high-speed driving logic and all other baseband and digital data and control electronics are implemented using standard CMOS processes on the same silicon substrate. The data decoder can be implemented on the receiver chip. A SiGe foundry, such as the Global Foundries foundry located near Essex Junction, Vt., with a 0.13-micron or 0.09-micron SiGe process can produce SiGe chips of the preferred design for 10 Gbps E-Band radio transceivers. A silicon foundry, such as TSMC in Taiwan, with a 0.028 micron Si CMOS process, can produce Si chips of the preferred design for 10 Gbps E-Band radio transceivers at even lower cost.

### Chip Design

Prior radio-on-a-chip designs have universally featured heterodyne and super-heterodyne circuits with relatively narrow (<1 GHz) baseband frequency channels for modulation and demodulation, because the symbol rate was constrained far below 1 billion symbols per second by the channel bandwidth available for microwave radios. Optimal designs for E-Band radio chips will utilize baseband modulation bandwidths of 1 to 5 GHz to make use of the preferential E-Band rules allowing occupation of up to 5 GHz of contiguous spectrum per half-duplex radio path.

### Transmitter Output Power

Ultimate output power is less important in E-Band radio than at lower frequencies, because rain fade quickly nullifies the benefits of a few dB of extra power even over a relatively short (approximately 1 km) link. Antenna gain is much higher at millimeter-wave—relative to microwave—for a given antenna size, so effective radiated power (ERP) is greatly enhanced by antennas of modest size, further reducing the importance of an expensive and reliability-limiting power amplifier in the transmitter. An optimal E-Band radio design will have a typical output power not exceeding 200 milliwatts, but with flat gain and phase characteristics across the full operating band of the radio (1 to 5 GHz) and allowing for a large dynamic range in output power. At frequencies above 70 GHz high humidity and heavy rainfall results in substantial increases in atmospheric attenuation, so any excess link margin at these frequencies is needed to cope with weather-related signal fade, rather than for increased modulation efficiency.

### Need for Low Order Modulation

The strong atmospheric attenuation associated with rain events is accompanied by large temporal variations in the signal amplitude and phase received from a remote transmitter. This effect makes it difficult to distinguish small differences in amplitude and phase imposed by a modulator from those imposed by the atmosphere, leading to high bit error rates from radios using high-order modulation schemes. The most robust modulation schemes are on-off keying and binary phase shift keying (OOK and BPSK), which require at least 1 Hz of bandwidth for each bit-per-second of data throughput. This modulation efficiency is acceptable for E-Band radios supporting up to at least 3.072 Gbps of data throughput (OBSAI protocols). For radios supporting 10-Gigabit Ethernet (10 Gig-E), the modulation efficiency must exceed 2 bits per second per Hz (e.g. 8PSK at 3 bits per second per Hz), but any higher order modulation schemes, typical of microwave radios, will be detrimental to radio performance.

### Need for Amplitude-Insensitive Demodulator

The need for large power margin to accommodate rain events will often require the E-Band transmitter to transmit into the compression region of the output power amplifier. The symbol demodulator must be designed to be insensitive to amplitude, relying only on a power threshold and the polarity of the demodulated signals, so that the transmitter power amplifier may be pushed into compression during heavy rain events without significant degradation of symbol discrimination (bit error rate).

### Output Power and Spectrum Gain Control

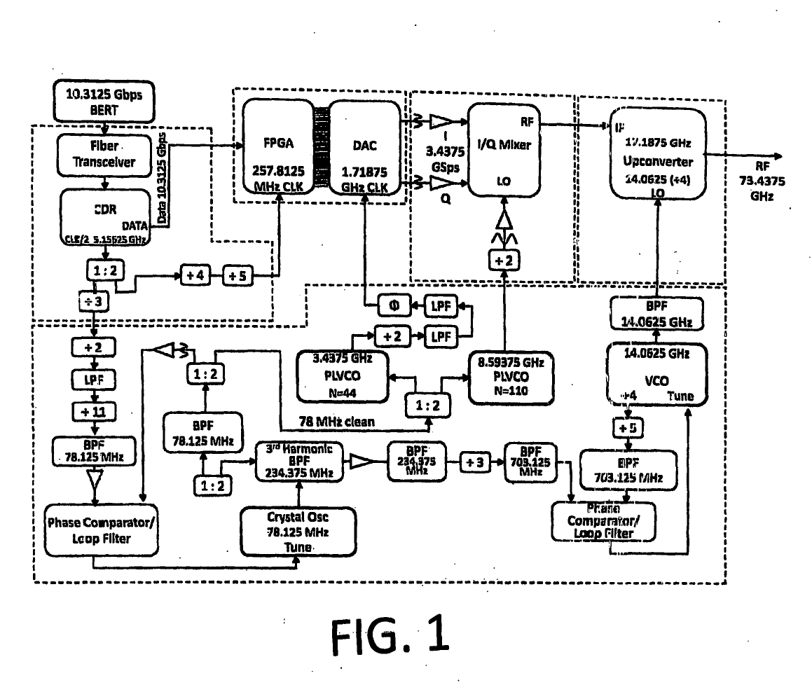

For this preferred embodiment shown in FIG. 1 operating at data rates of the 10.3125 Gbps the occupied transmit bandwidth is between 3.5 GHz and 5 GHz. The transceiver is designed to provide a power spectral density, over more than 70 percent of occupied bandwidth of the transmitter which is constant to within +/−1.5 dB and the transceiver provides a dynamic range in power output exceeding 15 dB.

### Comparison with Prior Art Chipset Radios

As explained in the background section recent advances in semiconductor technology have enabled the fabrication of increasingly complex mixed-signal (analog/digital) circuitry on a single integrated circuit chip or a chipset containing a minimal number of chips. Such circuitry has included analog microwave and millimeter-wave front-end amplifiers, filters, oscillators, and mixer/down-converters, as well as intermediate-frequency electronics, phase-lock loops, power control and back-end analog baseband circuitry, along with digital modulators and de-modulators, clock recovery circuits, forward error correction and other digital data management functions. Mixed-signal integrated chip solutions for wireless communications have universally evolved from RF frequencies below 1 GHz (e.g. 900 MHz handsets for wireless telephone in the home) to low microwave frequencies (analog/digital cell phone technology with carrier frequencies up to 2 GHz), to high microwave and low millimeter-wave frequencies (6 to 38 GHz) for wireless point-to-point broadband communications. Most recently, radio receivers and transmitters have been demonstrated using single-chip circuits at frequencies in the license-free band spanning 57 to 64 GHz. At these transmit frequencies the radios operate at very short distances due to the absorption of the radio beam by oxygen in air. These circuits have been based on techniques that have been successful to lower frequency radios. For example, these prior art radio-on-a-chip designs have featured heterodyne and super-heterodyne circuits with relatively narrow (<1 GHz) baseband frequency channels for modulation and demodulation, because the symbol rate was constrained far below 1 billion symbols per second by the channel bandwidth available for microwave radios. Embodiments of the present invention are designed to utilize the entire available bandwidth, greater than 1 GHz, for modulation and demodulation. Optimal designs for Applicants' radio chips will utilize baseband modulation bandwidths of 1 to 5 GHz to make use of the preferential rules including E-Band rules allowing occupation of up to 5 GHz of contiguous spectrum per half-duplex radio path.

### Benefits of 8PSK Modulation

At a given data rate, an 8PSK-modulated radio operates at a two-times higher symbol rate than a more common 64-QAM-modulated radio, necessitating higher-performance and more expensive digitizers, digital-to-analog converters, and digital logic components. However, the sparser 8PSK constellation allows error-free operation at 5 dB lower signal-to-noise ratio than 64-QAM. Because the signal is transmitted at full power for every constellation point, power efficiency is 8 dB higher than 64-QAM. Since amplitude is fixed for all constellation points, the transmitter need not be backed off from full power but can be operated well into compression, offering another 7 dB advantage over 64-QAM. Combined, these advantages contribute an additional 20 dB to the link margin for an 8PSK radio relative to an equivalent 64-QAM radio, which translates to about a 75% longer path reach in a “four nines” (99.99% weather available) path.

### A 10.3125 Gbps Transceiver

### Transmitter

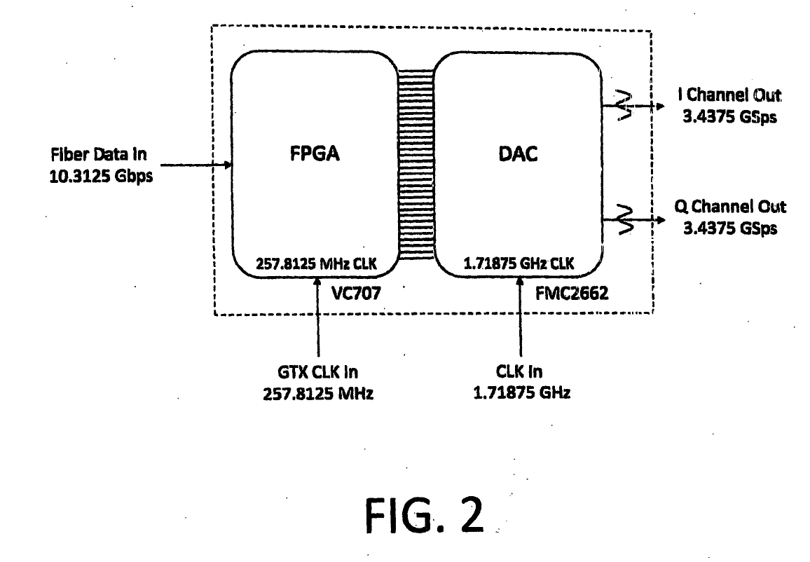

In a preferred embodiment, transmitters (shown in FIG. 1) for each radio transceiver supports a digital data rate of 10.3125 Gbps (10 Gigabits raw data per second plus IEEE 802.3 Clause 49 64b/66b encoding which accounts for the 0.3125 Gbps excess). Using 3-bit symbol encoding (differential 8PSK), the carrier phase is modulated at a symbol rate of 3.4375 billion-symbols-per-second, so as to fit easily into the 5 GHz channel modulation bandwidth allowed by the prevailing FCC band plan for E-Band communication. Serial data awaiting transmission is loaded at 10.3125 Gbps into a fast 40-bit serial buffer input of a Field-Programmable Gate Array (FIG. 2) and then clocked into the array processor at the slower rate of 257.8125 MHz (the ratio of the 10 GigE bit rate [i.e. 10.3125 Gbps] and the buffer length [40 bits]). In the FPGA, the bits are segmented sequentially into groups of three, one group representing each one data symbol to be transmitted by the D8PSK modulator.

### Gray Coding

Gray coding was invented in 1947 by Frank Gray of Bell Laboratories as a means of reducing the number of erroneous bits transmitted in a noisy signal channel or noisy switching environment. The basic tenet of the invention is that data errors most often arise from mistaking symbol phase near the boundary between phase states; for instance when the phase of a noisy signal measured at 157° degrees actually represents the 180° symbol state, but is interpreted to belong to the slightly closer 135° symbol state. For a simple encoding scheme it is possible for such adjacent symbol phases to represent strongly different bit sequences: for instance the 135° state might represent the bits ‘011’ while the 180° state represents the bits ‘100.’ In this case an error between the two adjacent states results in all three data bits being in error. The Gray code imposes a special sequence to the bit strings such that all adjacent phase states represent bit sequences that differ by only a single bit state, for instance:

| | |
|---|---|
| 0° | 000 |
| 45° | 001 |
| 90° | 011 |
| 135° | 010 |
| 180° | 110 |
| 225° | 111 |
| 270° | 101 |
| 315° | 100 |

### Differential Gray Coding

With differential Gray coding, the phase state represented by each three bit Gray code is imposed as a modulator phase shift, rather than an absolute phase, at the subsequent cycle of the symbol clock. This technique eliminates the need for the local transmitter and remote receiver to share knowledge of a common absolute phase reference.

### I/Q Modulator

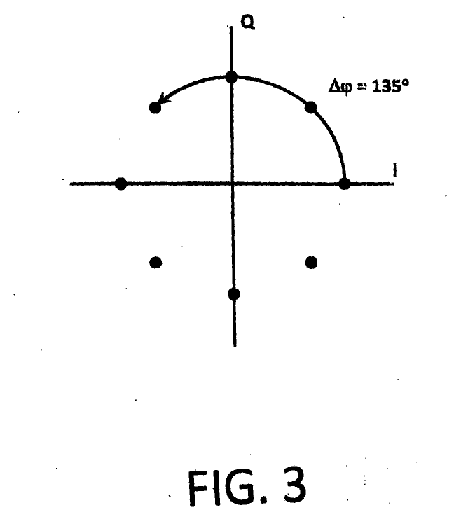

Differential Gray coding of the data stream yields a progression of phase jumps that modulate the MMW carrier to encode the data. Graphically, these phase jumps push the MMW carrier phase around a circle on the phase (or I/Q) plot, as shown in FIG. 3. For instance, when the remote receiver recognizes a phase jump near 135°, it recognizes the transmitted data string as a ‘010’, per the previous table. Signal vector phase is stepped in the transmitter modulator by use of a pair of mixers modulating an intermediate-frequency (IF) carrier in quadrature—that is to say on two separate channels that are separated by 90° of the IF carrier frequency (see FIG. 3). One channel, the “cosine,” or “in-phase” (I) channel, modulates the signal amplitude along the real (x) axis of the phase plot (figure N); the other channel, the “sine,” or “quadrature” (Q) channel, modulates the signal along the imaginary (y) axis. The vector plot of symbol amplitude and phase, accumulated over many symbol periods, becomes the symbol “constellation,” which is shown for D8PSK modulation in FIG. 3.

### Intermediate Frequency Phase Noise

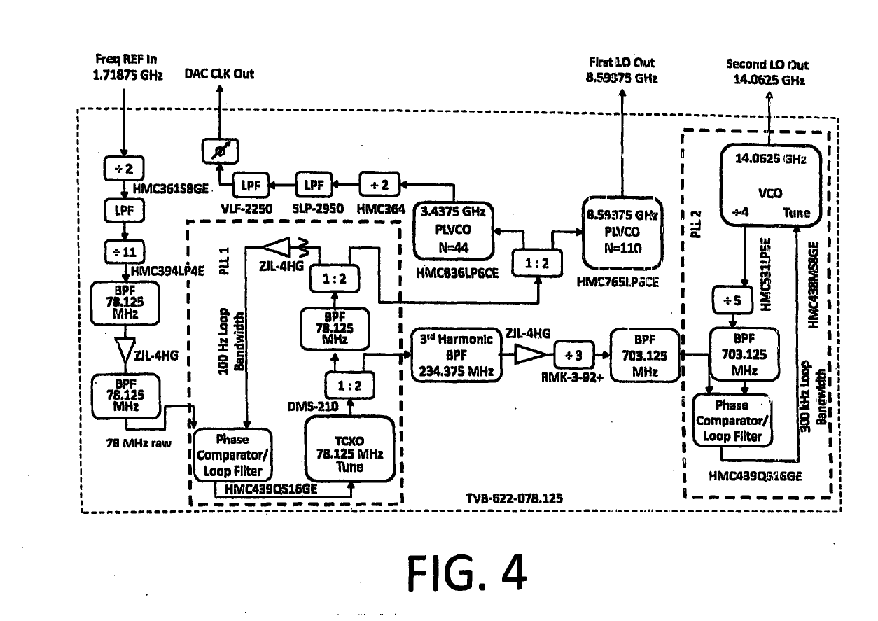

Bit-error performance of a digital data link is a statistical concept, based on the likelihood of phase and amplitude noise on the signal exceeding the phase and amplitude spacing between points on the constellation. The 8PSK constellation has only one amplitude state, so phase noise is much more important than amplitude noise in determining bit-error rate. The convenience of using Differential 8PSK encoding comes at a price in radio noise sensitivity, since both the preceding and the current bit contribute noise to the measurement of phase change at the clock cycle. In order to achieve error-free transmission (10⁻¹² bit-error rate), the threshold for phase noise on the IF signal should be very low (for example, about 0.6 degrees, or about 100×10⁻¹⁵ seconds of jitter). However, the use of differential encoding reduces constraints on phase noise considerably, since the phase jitter is only important as integrated over the short interval between the two successive symbols. Phase noise suppression to the required level is accomplished through the use a phase-locked voltage controlled oscillator, driven by high-quality temperature-controlled crystal oscillator at around 78.125 MHz, and a phase-lock loop with a loop bandwidth in the range of 100 Hz (FIG. 4).

### Digital-to-Analog Converters (DACs)

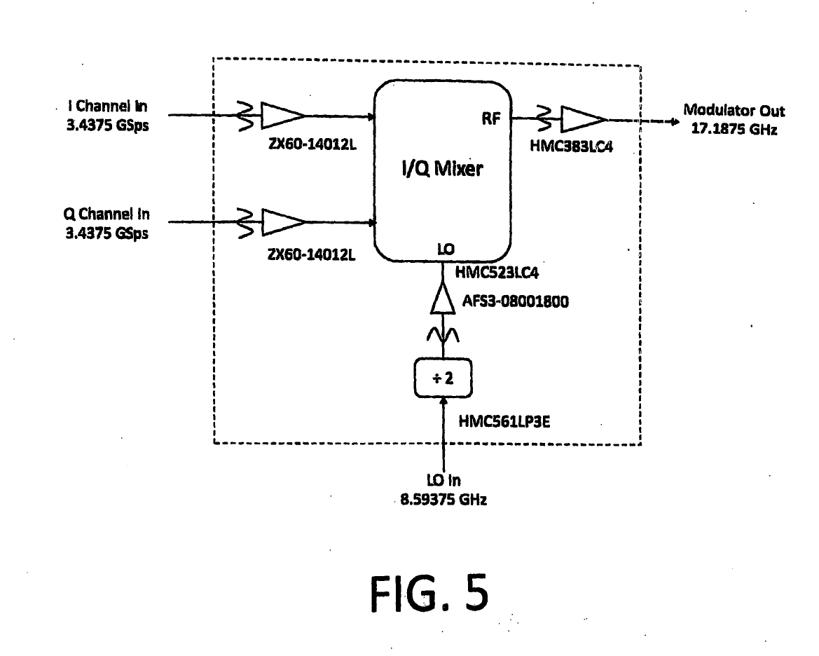

In order to jump to a specific position in the symbol constellation, the voltages at the vector modulator (I/Q mixer) inputs as shown in FIG. 5 must be driven to positive and negative levels proportional to the x- and y-magnitudes of the constellation point as shown in FIG. 3. Two independent DAC channels controlled by the FPGA (FIG. 2) are used to drive the x- and y-magnitudes. For D8PSK modulation, these DACs are driven to place the D8PSK constellation points at fixed 45° intervals around a fixed radius circle.

After each interval of the symbol clock (approximately 291×10⁻¹² seconds), three sequential bits of new data are evaluated by a D8PSK Gray Encoder in the transmitter FPGA to determine how far the phase should progress on the next cycle, and by comparison with the I/Q phase of the previous symbol, what precise carrier phase should be imposed by the I/Q mixer. At the next clock cycle, appropriate digital controls are sent to the two independent DAC channels to drive the carrier to that phase state.

### MMW Up-Converter

After vector (I/Q) modulation, the IF carrier is up-converted to the MMW transmit frequency and sent to the transmitter power amplifier and antenna.

### Up-Converter Phase Noise

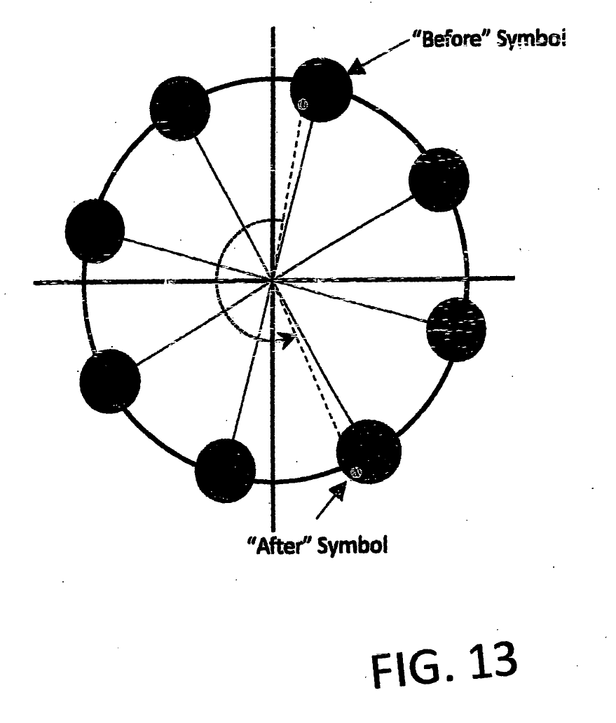

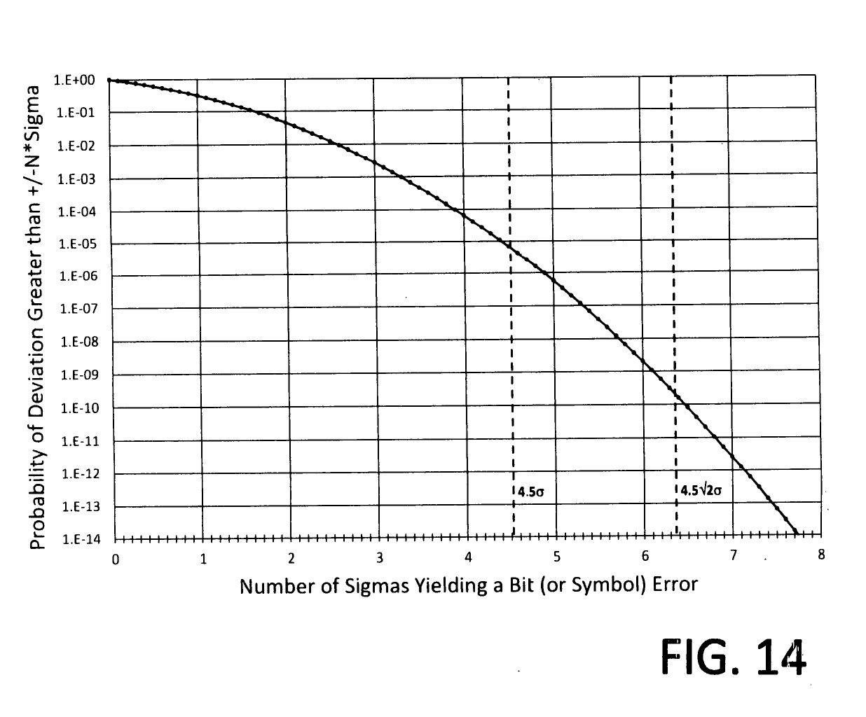

Similarly to the IF carrier, the phase noise of the upconverter oscillator affects the bit-error performance of the 10 GigE radio. A low-noise VCO is phase-locked at a multiple (9×) of the temperature-controlled crystal, with a loop bandwidth of about 300 kHz, to achieve a phase noise of about 2.2 degrees at near 60 GHz (100 fs of jitter), where it acts as the local oscillator to drive the MMW up-converter mixer (FIG. 14).

### System Clock

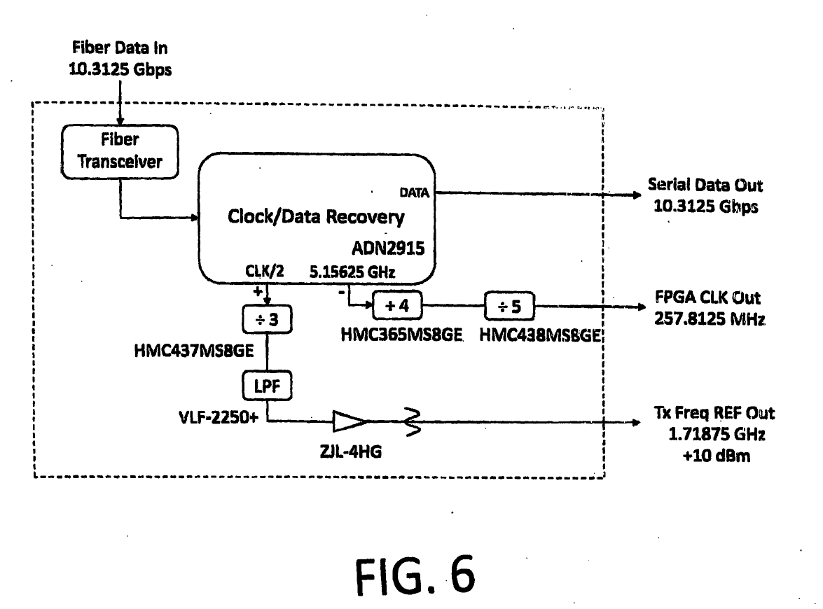

The master clock for the transmitter is derived from the 10 GigE input data line. A clock-and-data recovery circuit at the input (FIG. 6) strips the clock and divides it by 132 to tune the temperature-controlled crystal oscillator to a frequency near 78.125 MHz. Data clock jitter is smoothed by the ˜100 Hz loop bandwidth of a phase lock loop at the crystal frequency. The crystal oscillator then becomes the low-phase-noise reference frequency for both the IF carrier and the MMW upconverter. The recovered raw data clock is also divided by 40 to drive the FPGA clock each time the 40-bit serial data buffer is filled and ready for parallel transfer, and divided by 3 to drive the DAC at the 3.4375 GSps symbol rate.

A significant and critical feature of this timing architecture is that the MMW carrier frequency is in fact derived from the recovered GigE data clock, and is thereby allowed to “float” (within limits) with the input data rate. For a transmitter in the 71-76 GHz band, for instance, the data clock is divided by a factor of 132 to tune the 78.125 MHz crystal, and then split to two separate multipliers—a 220× multiplier that generates the first IF (17.1875 GHz), and a 720× multiplier that acts as the MMW upconverter local oscillator (56.25 GHz). The sum of these two frequencies, 73.4375 GHz, becomes the carrier frequency near the center of the 71-76 GHz band. The carrier frequency is thus a rational multiple of the data rate as follows: 10.3125*(220+720)/132=73.4735 GHz. For the 81-86 GHz Band, the IF multiplier changes from 220 to 204 and the MMW LO multiplier changes from 720 to 864, such that the carrier frequency becomes 10.3125*(204+864)/132=83.4375 GHz. This feature of a common frequency reference for data clock and carrier frequency generation allows the remote receiver to exactly recover the signal carrier frequency without a Costas loop, simply by repeating the rational multiplication sequence on the recovered data clock.

### Receiver

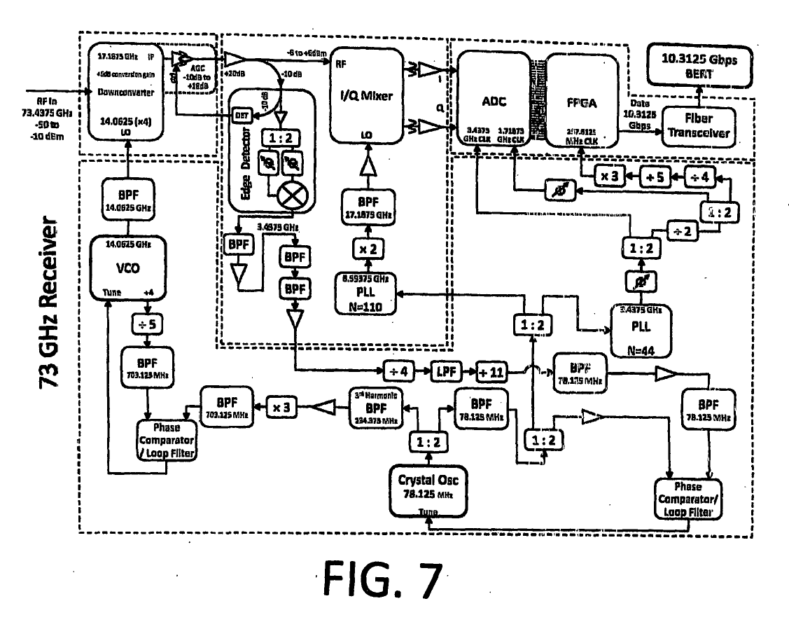

In this preferred embodiment, the receiver (FIG. 7) detects and demodulates the MMW signal from the remote D8PSK transmitter using clock and frequency references derived from the received data signal. This is made possible by the transmitter design feature that the RF carrier, the IF carrier and the symbol clock are all derived from the data clock recovered at the transmitter input.

### Down-Converter

In the receiver, the MMW signal is downconverted using the same frequency plan (RF, IF and baseband frequencies) used in the remote transmitter.

### Clock, Carrier and Data Recovery

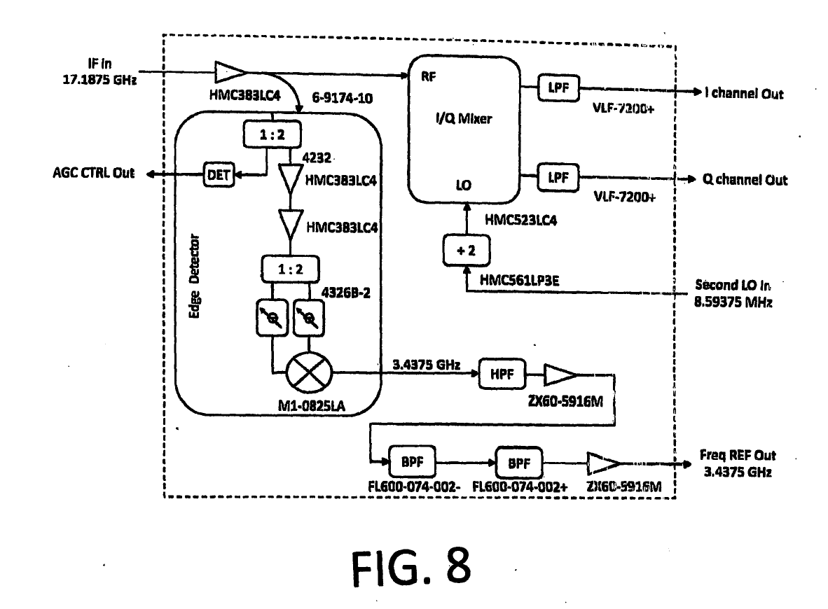

After down-conversion, the IF signal is fed to a data demodulator. Along this feed, a small portion of the signal power is split off and directed into an edge detector circuit to recover the clock from the remote transmitter (FIG. 8). In this sense the local receiver is the “slave” to the “master” clock generated at the remote transmitter. [This also highlights the fact that the local transmitter and local receiver do not share a common clock—each transmitter carries the master clock for the receiver at the other end of the link]. At the 10 GigE standard data rate of 10.3125 Gbps and for the D8PSK data modulation carrying 3 bits per symbol, the recovered clock is at or very near 3.4375 GHz.

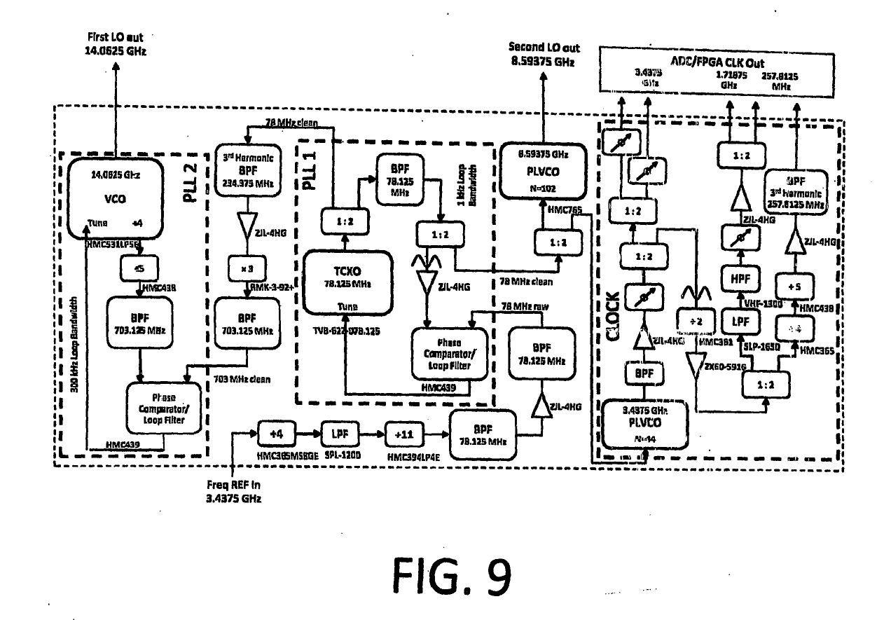

As in the transmitter, the recovered data clock reference is divided by a factor of 132 to tune an ultra-stable temperature-controlled crystal oscillator at 78.125 MHz (FIG. 9). In the receiver, this crystal is phase-locked at a loop bandwidth of 1 kHz, somewhat higher than the loop bandwidth used in the transmitter to allow it to track transmitter drifts, but low enough to minimize added phase noise and associated increase in the error vector magnitude (EVM) of the received signal constellation. The IF and MMW local oscillator frequencies are generated by the same integer multiples of the crystal oscillator frequency as those used in the remote transmitter, to lock the receiver to the carrier frequency of the remote transmitter, without the use of a Costas loop.

The larger fraction of the IF signal goes into an I/Q mixer of the same type used in the transmitter; here it is separated into its vector “in-phase” (I) and “quadrature-phase” (Q) channels. Since there is no absolute phase reference connecting the local receiver and remote transmitter, the recovered constellation may be rotated by an arbitrary amount relative to the transmitted constellation, but the Differential 8PSK encoding scheme ensures that only the phase change between symbols, and not the symbol phases themselves, are needed to decode the data.

### Edge Detector

Another significant and critical feature of the radio architecture is the edge detector that recovers the remote master clock. In this circuit, shown in FIG. 9, the IF signal is split into two equal parts and recombined (mixed) after imposing a differential time delay of a ½-period of the IF carrier frequency, equivalent to about 10% of a symbol period. In the absence of sudden jumps in phase, the two inputs to the mixer are then out of phase and the mixer output is nulled. However, when the phase changes abruptly at the start of a new symbol, there is a period of one-half IF cycle where the two mixer inputs are not perfectly out of phase, and the power level at the output of the mixer spikes temporarily before settling back to zero for the rest of the symbol period. The amplitude of transition spikes vary depending upon the degree of phase change at the individual symbol edges, but the output of the edge detector is amplified to strongly to clip the spikes and then filtered in a narrow band around 3.4375 GHz so that only the fundamental clock frequency and fiducial timing phase are preserved.

### Signal Demodulation

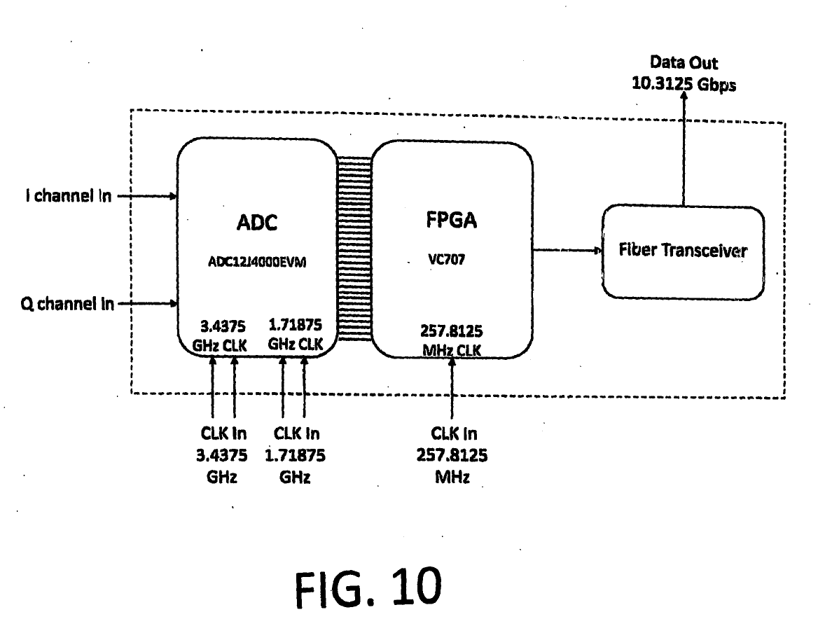

The I and Q outputs of the quadrature mixer are digitized in separate analog-to-digital converter (ADC) channels, and 12-bit digital data is streamed from each ADC synchronously into an FPGA (FIG. 10). In the FPGA, the I and Q waveforms are cleaned with an Inter-Symbol Interference (ISI) Equalization Filter to compensate signal distortion arising from band limiting of the transmitted signal. Vector phase is then determined through the ratio of the cleaned Q and I amplitudes (tangent of phase is Q/I) and compared with the phase of the previous symbol to determine the size of the phase jump. This measured phase jump is sorted into one of eight discrete 45-degree sector intervals and then compared against the Differential Gray Code table to recover the three bits encoded in the symbol step.

### ISI Equalization Filter

The transmitted spectrum is restricted, by FCC regulations, to a fixed bandwidth (5 GHz in each of the 71-76 and 81-86 GHz bands). At a transmit symbol rate of 3.4375 GSps, third- and higher harmonics of the modulation spectrum must be filtered out prior to transmission over the air. This filtering leads to distortion of the signal waveform that must be compensated in the receiver prior to signal decoding. The compensation is applied as a form of Finite Impulse Response (FIR) filter, created by comparing a received signal waveform with a known reference copy of that waveform as generated, prior to channel filtering, in the remote transmitter. An inverse transfer function is computed such as to digitally reciprocate the received waveform in the FPGA and recreate the original, undistorted modulation waveform prior to data decoding. The implemented filter samples and compensates the received waveform through impulse samples at a number of “taps,” separated by single periods of the symbol rate.

### Improving Bit Error Rates

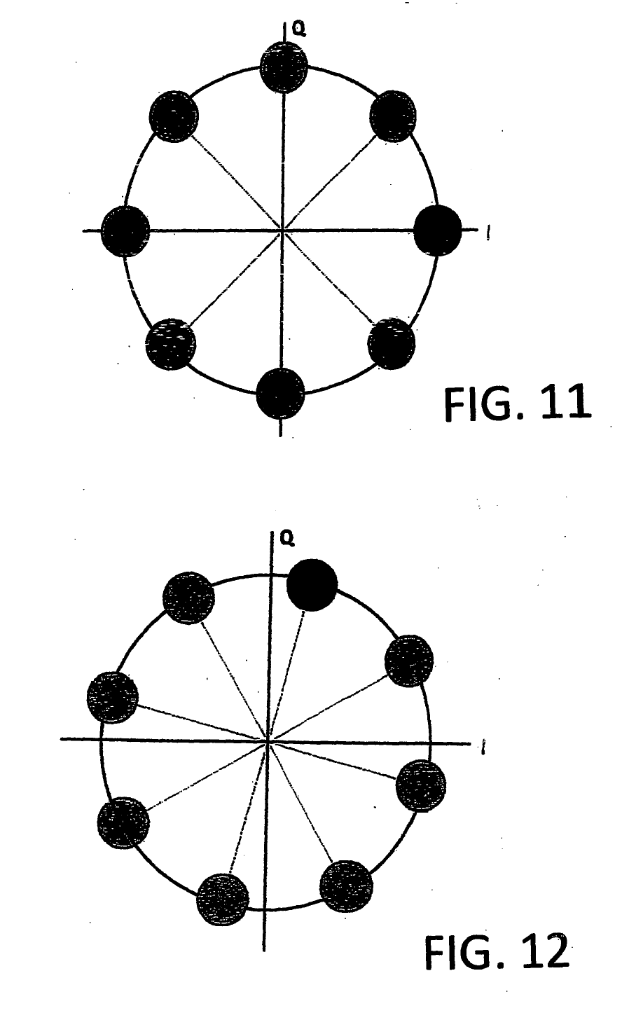

The following discussion focuses specifically on techniques and for improving bit error rates for differentially-encoded, eight-state phase-shift keyed (DE8PSK) modulator, although it can be generalized to any m-state phase modulator. For a DE8PSK radio, the transmitted symbol constellation is shown in FIG. 11 which is a symbol constellation of a radio using 8PSK modulation.

With DE8PSK modulation, data is encoded, three bits at a time, through the time sequence, or progression, of transmitted symbols. Any time the symbol rotates by one position in the counterclockwise direction, for instance, the encoded data stream could indicate the three-bit sequence 001. Any time the symbol rotates by two positions in the counter-clockwise direction, the encoded data stream could indicate 011, and so on; each of the eight possible three-bit binary sequences is uniquely identifiable by a number of steps (0 through 7) in the counterclockwise direction.

If the receiver's local frequency reference, used to demodulate the received signal waveform, is slightly offset from the frequency of the remote carrier, the constellation shown in FIG. 1 can rotate slowly, for instance to a position such as that shown in FIG. 12. This symbol constellation of an 8PSK radio shows an imperfect carrier recovery in the receiver that is rotating slowly in clockwise or counterclockwise direction relative to the constellation shown in FIG. 11.

This rotation will not change the formula for indicating data sequences; an inter-symbol counter-clockwise rotation of one or two positions would still represent 001 and 011 respectively, so absolute symbol phase becomes irrelevant, and small offset of reference and carrier frequencies is acceptable without consequence. This fact eases fidelity requirements on the receiver's carrier recovery technique, allowing for lower transceiver cost and complexity.

Measuring phase shift between symbols involves measurement of two phases—namely the “before” and “after” phases across the symbol transition. FIG. 13 shows nominal measurements of these phase measurements, each residing within a symbol “point cluster,” but each with a small amount of uncorrelated signal noise from thermal sources.

The number of counter-clockwise steps between data symbols is determined by measuring the vector angles of the “before” and “after” receive signals, taking the difference between these measurements, dividing by the step interval (in this case 45 degrees), and then rounding to the nearest integer. If the root-mean-square (RMS) deviation of each vector angle measurement from the ideal (noise-free) position—i.e. the centroid of each point cluster—is a given amount σ_{θ}, then the RMS error in the difference angle becomes:

σ_{(θ}_{₁}_{-θ}_{₂}₎=\sqrt{σ_{θ1}²+σ_{θ2}²}=\sqrt{2}σ_{θ} (1) (1)

Thus the differential measurement increases the angle error by a factor of the square root of two relative to the error in either of the two (“before” and “after”) angle measurements taken separately. The significant impact of this increased angle error for differentially-encoded radio performance is made evident by considering its impact on radio bit-error rate.

FIG. 14 shows a plot of the complementary error function erfc(x), which for Gaussian error distributions describes the likelihood of an individual measurement being separated from its mean value by more than a given number of standard deviations and indicating the likelihood that a certain measurement will fall outside of a given multiple of the RMS error away from its mean, assuming a Gaussian error distribution.

Referring to FIG. 14, an RMS error of 5 degrees in the phase shift measurement (for which 4.5σ=22.5°) leads to an error probability of approximately 10⁻⁵. By comparison, the corresponding error in the individual “before” and “after” phase measurements is 5/\sqrt{2}=3.54 degrees (for which 6.36σ=22.5°) and the error probability in assignation of either symbol to a given symbol cluster is approximately 10⁻¹⁰.

For DE8PSK modulation, the maximum error in measured phase shift which can be tolerated without generating a bit error is +/−22.5 degrees, or half of the 45 degree step between constellation clusters. For error larger than this threshold, the rounding step in the demodulation algoritlun will under- or overestimate the number of counterclockwise rotation quanta represented by the phase transition, thus leading to an error in the reconstructed bit stream. The significance of five orders of magnitude in raw bit error rate is reflected in the amount of throughput overhead needed to correct the bit errors that do occur. Correcting bit errors in a data stream with a raw BER of 10⁻⁵ requires an aggressive Forward Error Correction (FEC) algorithm with significant overhead (˜7%) to achieve a corrected BER of better than 10⁻²⁰. This overhead reduces achievable data rate within a given allocated radio frequency bandwidth. By comparison, a data stream with a raw BER of 10⁻¹⁰ needs an FEC algorithm with less than 1% overhead to achieve the same corrected BER, allowing significantly more data throughput over the allocated frequency band. Likewise the substantial link latency imposed by more aggressive FEC algorithms is highly detrimental to aggregated high-bandwidth backhaul applications. It is thus desirable to construct a means of achieving the benefits to link cost and complexity offered by differentially-encoded PSK, without incurring the higher noise associated with the differentiating process.

### Constellation Averaging Technique

The RMS noise shown in equation 1 for a differential phase shift measurement assumes that the noise level on the “before” and “after” phase states is the same. This is strictly true for measurements taken over equal symbol periods, as is the case for any constant-rate transmission. However, it is possible in principle to reduce the effective noise level of the “before” phase measurement, by including this measurement in an ensemble average of a large number of previous symbol vectors associated with the same constellation cluster.

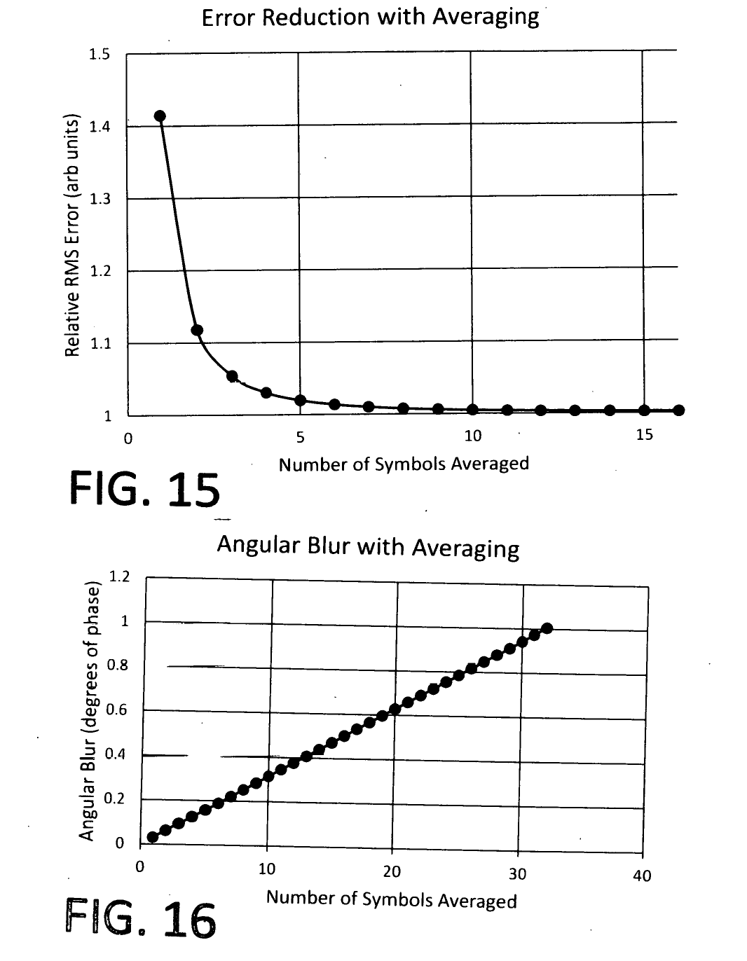

The optimum number of prior symbols to be included in the ensemble average is a balance between reducing differential phase error (which improves for larger ensembles) and blurring of the cluster centroid due to constellation rotation and carrier phase noise (which are made worse for larger ensembles). FIG. 15 shows the reduction in differential phase error and FIG. 16 shows the increase in phase blur associated with averaging over ensembles of different sizes, assuming a 10 GigE 8PSK transceiver with a 300 kHz difference in frequency between transmitted carrier and receiver-replicated carrier. Specifically FIG. 15 shows the RMS error reduction due to symbol averaging, relative to an ideal non-differential modulator, and FIG. 16 shows the integrated constellation rotation versus ensemble size, for a specified symbol rate and carrier frequency offset (3.4375 Gsps and 300 kHz respectively).

It is evident that most of the benefit of symbol averaging is achieved with ensembles as small as 8 symbols, while ensembles larger than 32 symbols may suffer measurable rotation blurring. Ensembles of 8 symbols bring the error down to within one percent of the asymptotic minimum (which is the theoretical error level that could be achieved by an ideal non-differential demodulator), while incurring a phase blur of less than 0.3 degrees (approximately 1% of the threshold for producing bit errors). For slower constellation rotation, larger ensembles might be used, but with minimal further impact in improving radio link performance.

### Constellation Averaging Algorithm

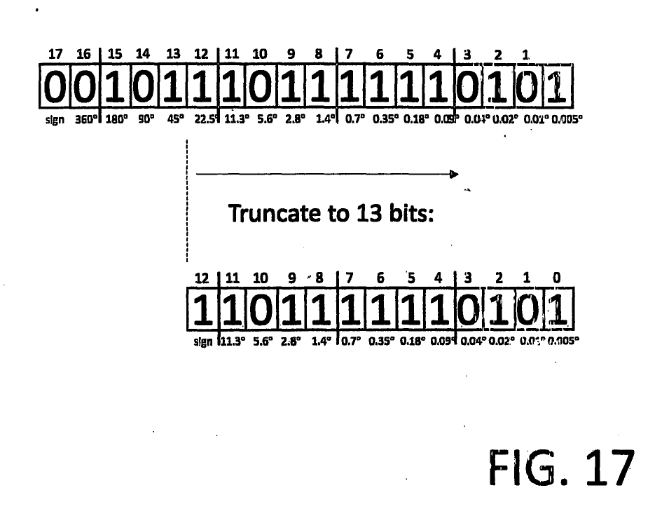

In order to make optimum use of fast mathematical processing in a Field-Programmable Gate Array or other custom digital ASIC, averaging is done on ensembles of size 2^{N}, with N an integer. This reduces the divide after summation to a simple bit truncation. For instance, a symbol's vector angle might be represented as a signed 17-bit hex datum, including the sign bit, a most significant bit corresponding to 360 degrees of phase, and 16 more bits with the phase represented by each successive bit corresponding to a halving of the previous bit phase, as shown in FIG. 17. This figure provides a binary representation of a symbol's vector phase, truncated to its modulo−45° residual for simplification of error averaging.

In this case, simple truncation of the hex datum to the thirteen least significant bits generates a signed, modulo−45° “remainder” that can be averaged over successive symbols and used to track the rotation of the constellation. Regardless of which symbol cluster a specific symbol falls into, this remainder reflects the rotating modulo−45° cluster centroid and the residual error of the individual symbol. In order to average 8 successive symbols, the 13-bit truncated values are summed to a 16-bit datum, and then the three least significant bits are dropped to generate the signed 12-bit data average. Once this average is updated for a new symbol, bits 17 to 13 of the original datum (as shown in FIG. 6) are concatenated back onto the average to regenerate the signed 17-bit symbol position, now “corrected” for its random error. This corrected value serves as the “before” symbol for comparison with the subsequent (uncorrected) symbol vector measurement in calculating the phase step between symbols. Using this averaging, the error in the differential phase coding modulator drops to within 1% of that of an ideal non-differential phase modulator, while providing a significant reduction m complexity and cost of the radio hardware. This technique and method were implemented on a Xilinx Virtex-7 FPGA and resulted in a five-order-of-magnitude improvement (from 10⁻⁷ BER before to 10⁻¹² BER after) in bit-error rate performance of a 10 GigE MMW radio link without FEC.

### Variations

Although a preferred embodiment of the present invention has been described in detail above, persons skilled in the radio art will recognize that many variations are possible within the scope of the present invention. Some variations are listed below

### Other High Data Rate Millimeter Radios

Applicant has described a preferred embodiment of a radio supporting a data rate of 10 Gbps using a differential octal phase shift keyed (D8PSK) modulator; however the radio on a chip or minimal chipset should not be considered to be bound by this data rate or modulation approach. Indeed at lower data rates, more robust modulation approaches such as DBPSK or DQPSK may be employed and would allow for bit-error-free operation at lower link margins.

A popular data transfer standard supported by one radio sold by Applicant is the Gigabit-Ethernet (GigE) standard which exchanges data at a rate of 1.25 Gbps. At this rate, and for data rates up to about 3.5 Gbps, the preferred modulation scheme is Differential Binary Phase Shift Keying (DBPSK), where the difference between phase states (180 degrees) is four times larger than for D8PSK (45 degrees), and consequently a lower signal-to-noise ratio is required to distinguish between phase states. The DBPSK design is described in parent application Ser. No. 12/928,017 which has been incorporated herein by reference. In accordance with the present invention these circuits would be fabricated on a single chip or chipset utilizing well-known integrated circuitry fabrication techniques as explained above with respect to the first preferred embodiment. Beyond data rates of 3.5 Gpbs, the Federal Communication Commission allocated channel bandwidth becomes insufficient to support the modulation rates, and it becomes necessary to transmit data “symbols” representing more than one data bit at a time. For radios supporting data transfer rates between 3.5 Gbps and about 7 Gbps, the preferred modulation approach is Differential Quadrature Phase Shift Keying (DQPSK), in which two bits of data are sent simultaneously within each “symbol,” and the spacing between the four possible symbol phase states is 90 degrees. For radios supporting data rates between 7 Gbps and about 10.5 Gbps, the preferred modulation approach is Differential Octal Phase Shift Keying (D8PSK), in which three bits of data are sent simultaneously, as described in the first preferred embodiment for this patent. For radios supporting even higher data rates the modulation scheme is chosen to send four or more bits of data simultaneously, and the link margin (or signal-to-noise ratio) required for maintaining error-free transmission becomes successively higher.

### Even Higher Data Rates

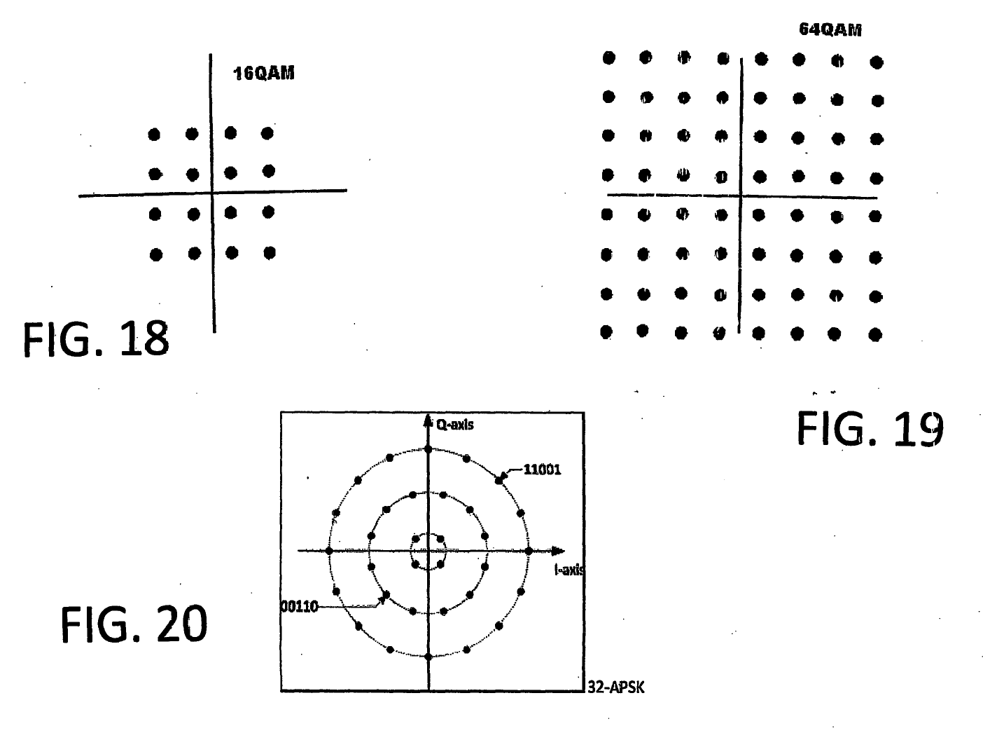

For data rates in excess of 10.5 Gbps, progressively higher order modulation schemes are necessary. Symbol constellations on 16 symbols, such as 16-QAM, encode 4 bits per symbol, supporting data rates up to 14 Gbps. (See FIG. 18.) Constellations of 32 symbols, such as 32-state Amplitude and Phase Shift Keying (32-APSK), encode 5 bits per symbol, supporting data rates of 17.5 Gbps. (See FIG. 20 Constellations of 64 symbols (see FIG. 19), such as 64-QAM, encode 6 bits per symbol and support data rates to 21 Gbps, and so on. Successively higher order modulation schemes impose higher and higher signal-to-noise requirement thresholds and greater restrictions on amplifier linearity, so extension to infinite data rates is not practical. The use of differential encoding, and in particular prior-symbol averaging to reduce demodulation noise and improve bit-error rate performance (as described above) applies to such higher modulation schemes as well as to DEMPSK. For a symbol constellation that is slowly rotating due to oscillator phase noise and/or imperfect carrier frequency recovery, integrating the centroid of each constellation point over a period short compared to that for which the rotation blurs two points into one, reduces the demodulation noise contribution from small displacements of the prior symbol and thereby drives the BER performance asymptotically toward that of non-differential encoding at the same modulation order.

Chip-based radio transceivers designed for a range of data transfer rates less than the threshold rates of 3.5 Gbps, will preferably include modulator/demodulators of the DBPSK types. For data rates above 3.5 Gbps and below 7.0 Gbps, DQPSK is preferred. And for rates above 7.0 Gbps and below 10.5 Gbps, D8PSK is preferred.

### Silicon-Germanium Semiconductors

The components of the millimeter wave radios described above are in general state of the art millimeter wave and optical fiber components. However, many of the components could be fabricated together on one or more semiconductor substrates to produce very low cost millimeter wave radios. Silicon-germanium bipolar transistors on complementary metal-oxide-semiconductor (referred to as “SiGe BiCMOS”) technology, which marries the superior low-noise and high-speed properties of the SiGe heterojunction bipolar transistors with the low cost and manufacturability advantages of conventional CMOS technology, represent an ideal solution for mixed-signal applications such as millimeter-wave wireless communications systems, in which frequency sources and multipliers, mixers and low-noise amplifiers are used alongside digital modulator control and processing circuitry. Amplifiers using SiGe bipolar transistors are more efficient and achieve lower noise figures than comparable conventional CMOS amplifiers, and the higher breakdown voltage of SiGe allows for higher device output power as well.

### High Frequency Radio Components on Si and SiGe

Gallium Arsenide (GaAs) is superior to SiGe semiconductors for ultra-low phase noise high-frequency oscillators (so an external microwave phase-locked voltage-controlled oscillator (PLVCO) is a preferred frequency source), but the frequency multiplier chain, up-conversion and down-conversion mixers and millimeter-wave, microwave and baseband amplifiers can all be implemented satisfactorily using conventional micro-strip circuitry on Si and SiGe semiconductor substrates. For lowest cost, a silicon wafer can be used as a substrate, with germanium placed locally on the chip at the locations of the millimeter-wave transistors and diodes, so that the more expensive SiGe material is localized only in the regions of the high-frequency MMW and microwave semiconductor junctions. Lower frequency circuitry, including the data encoder, high-speed driving logic and all other baseband and digital data and control electronics may be implemented using standard CMOS processes on the same silicon substrate. Recent advances in Si processing to 28-nm process feature sizes have enabled transistor cutoff frequencies above 100 GHz on pure silicon substrates as well. A SiGe foundry, such as the IBM foundry located near Essex Junction, Vt., with a 0.13-micron or 0.09-micron SiGe process can produce SiGe chips of the preferred design for 10 Gbps E-Band radio transceivers. And as indicated above, a Si-CMOS foundry with a 28-nm process in Taiwan can likewise produce chips of the preferred design at an even lower price.

### Other Variations

The radio described in this patent is capable of delivering data rates in excess of 3.5 Gigabits per second. The preferred embodiments in this description operate under the Internet Protocol (IP) Ethernet Standard at 10 Gigabits per second with a small amount of overhead for ensuring bit toggling at some minimum speed. There are, however, many other communications standards which involve serial transfer of binary data at speeds in excess of 3.5 Gigabits per second and within the maximum bandwidth capability of this radio. Some of these include:

### SONET OC-96 (4.976 Gbps)

### 4×Gig-E (5.00 Gbps)

### 5×Gig-E (6.25 Gbps)

### OBSAI RP3-01 (6.144 Gbps)

### 6×Gig-E (7.50 Gbps)

### Fibre Channel 8GFC (8.5 Gbps)

### SONET OC-192 (9.952 Gbps)

### Fibre Channel 10GFC Serial (10.52 Gbps)

The High Data Rate Wireless Communications Radio described in this patent will support all of these protocols and a variety of others, up to a maximum data rate of about 13 Gbps. In preferred embodiments operating at data rates in the range of about 3.5 Gbps the occupied transmit bandwidth should be between 1.0 GHz and 5 GHz. For the higher data rates the transmit bandwidth will preferably be in a range closer to the 5 GHz limit.

Therefore readers should determine the scope of the present invention by reference to the appended claims.

What is claimed is:

1. A two-transceiver E-Band radio link, defining a first transceiver and a second transceiver, with 8PSK modulation and demodulation, capable of 10.3125 Gbps operation, said link comprising:
A. a first transceiver adapted to transmit at a first E-Band frequency band and to receive at a second E-Band frequency band, each of the two bandwidths, defining a first and second E-Band bandwidth, each being at least as wide as 3.5 GHz, said transceiver comprising:
1) transmitter front-end circuitry adapted to receive a binary input data stream with a capability of producing output signals at data rates at least as fast as 10.3125 Gbps utilizing 8PSK modulation of an E-Band carrier signal, said transmitter front-end circuitry comprising:
a. encoding circuitry adapted to encode input binary signals to produce encoded signals, with each encoded signal comprising three bits; and
b. 8PSK modulation circuitry adapted to phase shift the millimeter wave carrier signal based on the encoded signals to produce a phase-shifted carrier signal at the first E-Band frequency band with each phase of the signal defining one of eight phases, having spacing between the phases of about 45 degrees or a multiple of about 45 degrees;
2) receiver circuitry adapted to receive incoming E-Band signals transmitted from the second transceiver at the second E-Band frequency millimeter wave transmitter, said receiver circuitry comprising:
a. millimeter wave amplifier circuitry adapted to amplify incoming E-Band signals;
b. demodulation circuitry adapted to demodulate the amplified incoming millimeter wave signals to produce a binary output data stream;
3) radio transmit and receive components adapted transmit and receive phase shifted E-band radio signals to and from the second transceiver, said radio components comprising:
a. a millimeter wave amplifier circuit adapted to amplify phase shifted carrier signal to produce an amplified phase shifted transmit E-Band radio beam,
b. a millimeter wave amplifier circuit adapted to amplify phase shifted carrier signals received from the second transceiver;
4) an antenna system adapted to convert the phase shifted E-band radio transmit beams to produce a narrow band E-Band “pencil beam” confined within a single narrow channel less than 1.2 degrees wide and to collect phase shifted E-band radio beams transmitted from the second transceiver;
B. a second transceiver adapted to transmit at a first E-Band frequency band and to receive at a second E-Band frequency band, each of the two bandwidths, defining a first and second E-Band bandwidth, each being at least as wide as 3.5 GHz, said transceiver comprising:
1) transmitter front-end circuitry adapted to receive a binary input data stream with a capability of producing output signals at data rates at least as fast as 10.3125 Gbps utilizing D8PSK modulation of an E-Band carrier signal, said transmitter front-end circuitry comprising:
a. encoding circuitry adapted to encode input binary signals to produce encoded signals, with each encoded signal comprising three bits; and
b. 8PSK modulation circuitry adapted to phase shift the millimeter wave carrier signal based on the encoded signals to produce a phase-shifted carrier signal at the first E-Band frequency band with each phase of the signal defining one of eight phases, having spacing between the phases of about 45 degrees or a multiple of about 45 degrees;
2) receiver circuitry adapted to receive incoming E-Band signals transmitted from the second transceiver at the second E-Band frequency millimeter wave transmitter, said receiver circuitry comprising:
a. millimeter wave amplifier circuitry adapted to amplify incoming E-Band signals;
b. demodulation circuitry adapted to demodulate the amplified incoming millimeter wave signals to produce a binary output data stream;
3) radio transmit and receive components adapted transmit and receive phase shifted E-band radio signals to and from the first transceiver, said radio components comprising:
a. a millimeter wave amplifier circuitry adapted to amplify phase shifted carrier signal to produce an amplified, phase-shifted transmit E-Band radio beam,
b. a millimeter wave amplifier circuitry adapted to amplify phase-shifted carrier signals received from the first transceiver;
4) an antenna system adapted to convert the phase-shifted E-band radio transmit beams to produce a narrow band E-Band “pencil beam” confined within a single narrow channel less than 1.2 degrees wide and to collect phase-shifted E-band radio beams transmitted from the first transceiver;
wherein a constellation averaging technique is utilized to improve bit error rates.

2. The radio link as in claim 1 wherein all or mostly all of the transmitter front-end circuitry and the receiver circuitry of both transceivers are fabricated on a single chip or chipset,

3. The radio link as in claim 1 wherein the 8PSK modulation circuitry is D8PSK modulation circuitry.

4. The radio link as in claim 1 wherein the transmitter front end circuitry of both transceivers are adapted to derive their internal clock references directly from 10 GbE fiber or coaxial cable data input.

5. The radio link as in claim 4 wherein the transmitter front end circuitry of both transceivers are adapted to generate symbol clock, intermediate frequencies and transmit frequencies from their internal clock references.

6. The radio link as in claim 5 wherein the receiver circuitry in both transceivers derive their receiver symbol clock from their 10 GBE antenna data input with a result that receiver internal symbol clock of each of the transceivers is slaved to the transmitter clock of the other transceiver and fully independent of internal transmit clock of the transceiver.

7. The radio link as in claim 6 wherein the receiver circuitry of each of the two transceivers utilizes an edge detector comprised of a delay and sum interference circuit, using a half wave delay of the intermediate frequency receive signal to detect and synchronize to phase jumps in order to generate an internal receiver clock.

8. The radio link as in claim 7 wherein the receiver circuitry of each of the two transceivers is adapted to generate its symbol clock, intermediate frequencies and local oscillator frequencies from its internal edge-detector derived clock eliminating a need for a Costas loop or other carrier recovery circuit.

9. The radio link as in claim 8 wherein the receiver circuitry of each of the two transceivers is adapted to decode data based on differential phase between successive symbols, eliminating a need for a common phase reference with the transmitter of the other transceiver.

10. The radio link as in claim 1 wherein the chips or chipsets are comprised of silicon germanium or gallium arsenide.

11. The radio link as in claim 7 wherein the receiver circuitry of each of the two transceivers is fabricated utilizing silicon complementary metal-oxide semiconductor (Si CMOS) technology.

12. The radio link as in claim 11 wherein a plurality of peripheral radio components are external to the chips or chipsets.

13. The radio link as in claim 12 wherein the plurality of peripheral radio components include some or all of the following components: fiber-optic transceivers, frequency generators, filters, power supplies and regulators, high-power amplifiers, diplexers and antenna systems.

14. The radio link as in claim 1 wherein front-end analog electronics, including amplifies, clock recovery, mixers, frequency multiplies and dividers, edge detectors, and phase comparators, and digital processing electronics, including digitizers, FPGA's, digital to analog converters, are fabricated on a single all-silicon CMOS semiconductor chips or chipsets.

15. The radio link as in claim 1 wherein the transceivers are adapted to operate in accordance with a protocol or standard chosen from the following group of protocols or standards:
SONET OC-96 (4.976 Gbps)
4×Gig-E (5.00 Gbps)
5×Gig-E (6.25 Gbps)
OBSAI RP3-01 (6.144 Gbps)
6×Gig-E (7.50 Gbps)
Fibre Channel 8GFC (8.5 Gbps)
SONET OC-192 (9.952 Gbps)
Fibre Channel 10GFC Serial (10.52 Gbps)

16. The radio link as in claim 1 wherein the transmitters and the receivers transmit and receive through separate antennas.

17. The radio link as in claim 1 wherein the transmitters are adapted to provide a dynamic range in power output exceeding 15 dB.

18. The radio links as in claim 1 wherein the transmitter and the receiver portions of the transceivers are contained in a single enclosure.

19. The radio links as in claim 1 wherein the transmitter and the receiver portions of the transceiver are contained in separate enclosures.

20. The radio link as in claim 1 wherein the transmitters and the receivers transmit and receive through a single antenna.

21. The radio as in claim 1 wherein the link includes a processor programmed to include a constellation averaging algorithm for reduction bit error rates.

22. The link as in claim 21 wherein the reduction in bit error rate is a five order magnitude reduction.
